(19) United States
(12) Patent Application Publication
(10) Pub. No.: US 2015/0006962 A1
(43) Pub. Date: Jan. 1, 2015

(54) MEMORY DUMP WITHOUT ERROR CONTAINMENT LOSS

(71) Applicants: Robert C. Swanson, Olympia, WA (US); Robert W. Cone, Portland, OR (US); Madhusudhan Rangarajan, Round Rock, TX (US); Mallik Bulusu, Olympia, WA (US); Robert Bahnsen, Tacoma, WA (US)

(72) Inventors: Robert C. Swanson, Olympia, WA (US); Robert W. Cone, Portland, OR (US); Madhusudhan Rangarajan, Round Rock, TX (US); Mallik Bulusu, Olympia, WA (US); Robert Bahnsen, Tacoma, WA (US)

(21) Appl. No.: 13/929,562

(22) Filed: Jun. 27, 2013

(51) Int. Cl. G06F 11/36

(52) U.S. Cl. CPC G06F 11/366
USPC 714/38.11

(57) ABSTRACT

A viral condition is identified in a system that causes input/output operations to be restricted during the viral condition. Crash dump data is enabled to be written to a particular region of volatile memory during the viral condition. Further, extraction of the crash dump data to fixed memory is initiated during the viral condition.

### FIELD

This disclosure pertains to computing system, and in particular (but not exclusively) to crash dumps.

### BACKGROUND

Computing systems encounter occasional errors, including catastrophic or critical errors that can cause the system to “crash,” evidenced infamously in some cases by the “blue screen of death.” Computing systems can include functionality for collecting data from memory, such as system random access memory (RAM) and other memory, that describe conditions and attributes of the system and its components leading up to and at the time of the error. This data can be saved and then analyzed.

Some computing architectures, such as interconnect architectures, can provide for a viral status in response to certain types of errors that causes an alert to be propagated throughout the system, utilizing the interconnect architecture, so that each component is alerted of the error. Transactions within the system can be caused to be blocked as each component is informed of the viral condition and underlying error. Viral status can be utilized to ensure containment of the error, such that the error and data corrupted by the error condition do not propagate and “infect,” or affect, multiple other components of the system.

### BRIEF DESCRIPTION OF THE DRAWINGS

FIG. 1 illustrates an embodiment of a block diagram for a computing system including a multicore processor.

FIG. 2 illustrates an embodiment of a computing system including an interconnect architecture.

FIG. 3 illustrates embodiments of multi-processor configurations utilizing a high performance interconnect architecture.

FIG. 4 illustrates an embodiment of a layered stack for a high performance interconnect architecture.

FIG. 5 illustrates a flowchart showing an example work-around for performing a memory dump in connection with a viral condition within a system.

FIG. 6 illustrates an embodiment of a block diagram for an example computing system to perform a protected memory dump during a viral condition within the computing system.

FIG. 7 illustrates a flowchart showing an example initialization of example protected memory dump functionality.

FIG. 8 illustrates a flowchart showing an example protected memory dump.

FIGS. 9A-9C illustrate flowcharts showing example techniques performed in connection with example protected memory dump functionality.

FIG. 10 illustrates another embodiment of a block diagram for a computing system.

Like reference numbers and designations in the various drawings indicate like elements.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the invention described herein.

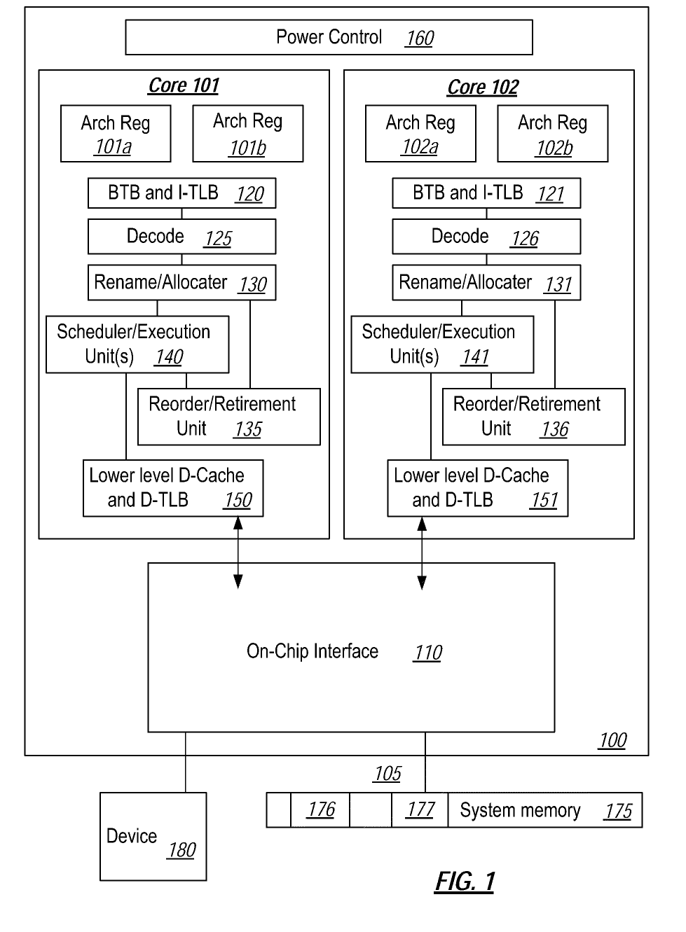

Referring to FIG. 1, an embodiment of a block diagram for a computing system including a multicore processor is depicted. Processor 100 includes any processor or processing device, such as a microprocessor, an embedded processor, a digital signal processor (DSP), a network processor, a handheld processor, an application processor, a co-processor, a system on a chip (SOC), or other device to execute code. Processor 100, in one embodiment, includes at least two cores—core 101 and 102, which may include asymmetric cores or symmetric cores (the illustrated embodiment). However, processor 100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores—core 101 and 102. Here, core 101 and 102 are considered symmetric cores, i.e. cores with the same configurations, functional units, and/or logic. In another embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such as binary translation, may be utilized to schedule or execute code on one or both cores. Yet to further the discussion, the functional units illustrated in core 101 are described in further detail below, as the units in core 102 operate in a similar manner in the depicted embodiment.

As depicted, core 101 includes two hardware threads 101a and 101b, which may also be referred to as hardware thread slots 101a and 101b. Therefore, software entities, such as an operating system, in one embodiment potentially view processor 100 as four separate processors, i.e., four logical processors or processing elements capable of executing four software threads concurrently. As alluded to above, a first thread is associated with architecture state registers 101a, a second thread is associated with architecture state registers 101b, a third thread may be associated with architecture state registers 102a, and a fourth thread may be associated with architecture state registers 102b. Here, each of the architecture state registers (101a, 101b, 102a, and 102b) may be referred to as processing elements, thread slots, or thread units, as described above. As illustrated, architecture state registers 101a are replicated in architecture state registers 101b, so individual architecture states/contexts are capable of being stored for logical processor 101a and logical processor 101b. In core 101, other smaller resources, such as instruction pointers and renaming logic in allocator and renamer block 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register(s), low-level data-cache and data-TLB 120, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 includes a simplified, representative out-of-order (OOO) processor core. But an in-order processor may be utilized in different embodiments. The OOO core includes a branch target buffer 120 to predict branches to be executed/taken and an instruction-translation buffer (I-TLB) 120 to store address translation entries for instructions.

Core 101 further includes decode module 125 coupled to fetch unit to decode fetched elements. Fetch logic, in one embodiment, includes individual sequencers associated with thread slots 101a, 101b, respectively. Usually core 101 is associated with a first ISA, which defines/specifies instructions executable on processor 100. Often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA. For example, as discussed in more detail below decoders 125, in one embodiment, include logic designed or adapted to recognize specific instructions, such as transactional instruction. As a result of the recognition by decoders 125, the architecture or core 101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 126, in one embodiment, recognize the same ISA (or a subset thereof). Alternatively, in a heterogeneous core environment, decoders 126 recognize a second ISA (either a subset of the first ISA or a distinct ISA).

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 101 and 102 share access to higher-level or further-out cache, such as a second level cache associated with on-chip interface 110. Note that higher-level or further-out refers to cache levels increasing or getting further way from the execution unit(s). In one embodiment, higher-level cache is a last-level data cache—last cache in the memory hierarchy on processor 100—such as a second or third level data cache. However, higher level cache is not so limited, as it may be associated with or include an instruction cache. A trace cache—a type of instruction cache—instead may be coupled after decoder 125 to store recently decoded traces. Here, an instruction potentially refers to a macro-instruction (i.e. a general instruction recognized by the decoders), which may decode into a number of micro-instructions (micro-operations).

In the depicted configuration, processor 100 also includes on-chip interface module 110. Historically, a memory controller, which is described in more detail below, has been included in a computing system external to processor 100. In this scenario, on-chip interface 11 is to communicate with devices external to processor 100, such as system memory 175, a chipset (often including a memory controller hub to connect to memory 175 and an I/O controller hub to connect peripheral devices), a memory controller hub, a northbridge, or other integrated circuit. And in this scenario, bus 105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 175 may be dedicated to processor 100 or shared with other devices in a system. Common examples of types of memory 175 include DRAM, SRAM, non-volatile memory (NV memory), and other known storage devices. Note that device 180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 100. For example in one embodiment, a memory controller hub is on the same package and/or die with processor 100. Here, a portion of the core (an on-core portion) 110 includes one or more controller(s) for interfacing with other devices such as memory 175 or a graphics device 180. The configuration including an interconnect and controllers for interfacing with such devices is often referred to as an on-core (or un-core configuration). As an example, on-chip interface 110 includes a ring interconnect for on-chip communication and a high-speed serial point-to-point link 105 for off-chip communication. Yet, in the SOC environment, even more devices, such as the network interface, co-processors, memory 175, graphics processor 180, and any other known computer devices/interface may be integrated on a single die or integrated circuit to provide small form factor with high functionality and low power consumption.

In one embodiment, processor 100 is capable of executing a compiler, optimization, and/or translator code 177 to compile, translate, and/or optimize application code 176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

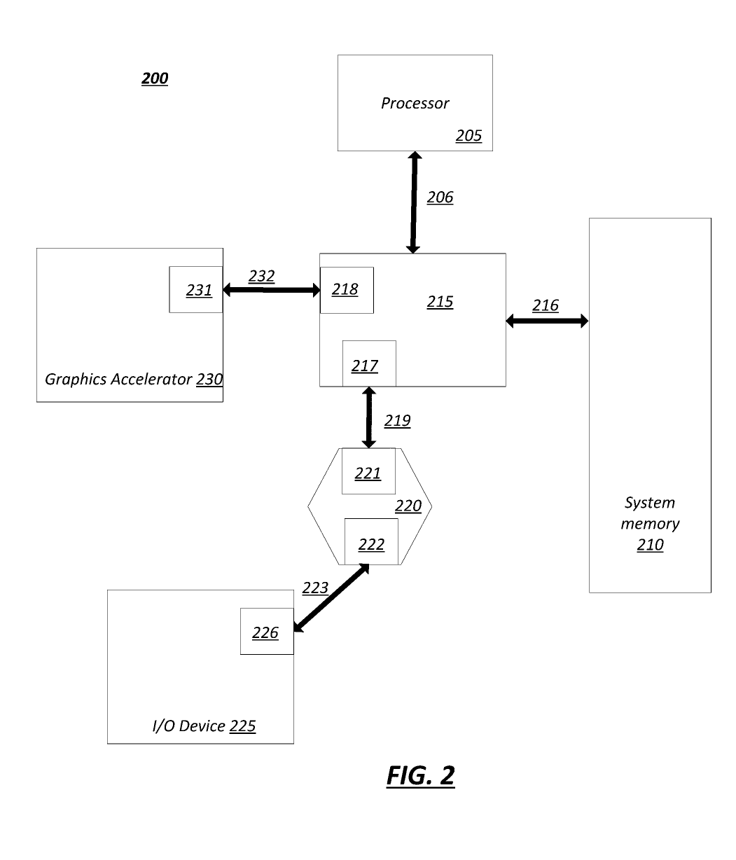

Example interconnect fabrics and protocols can include such examples a Peripheral Component Interconnect (PCI) Express (PCIe) architecture, Intel QuickPath Interconnect (QPI) architecture, Mobile Industry Processor Interface (MIPI), among others. An interconnect fabric can enable components and devices from different vendors to inter-operate in an open architecture, spanning multiple market segments; Clients (Desktops and Mobile), Servers (Standard and Enterprise), and Embedded and Communication devices. Referring to FIG. 2, an embodiment of an example fabric composed of point-to-point Links that interconnect a set of components is illustrated. System 200 includes processor 205 and system memory 210 coupled to controller hub 215. Processor 205 includes any processing element, such as a microprocessor, a host processor, an embedded processor, a co-processor, or other processor. Processor 205 is coupled to controller hub 215 through front-side bus (FSB) 206. In one embodiment, FSB 206 is a serial point-to-point interconnect as described below. In another embodiment, link 206 includes a serial, differential interconnect architecture that is compliant with different interconnect standard.

System memory 210 includes any memory device, such as random access memory (RAM), non-volatile (NV) memory, or other memory accessible by devices in system 200. System memory 210 is coupled to controller hub 215 through memory interface 216. Examples of a memory interface include a double-data rate (DDR) memory interface, a dual-channel DDR memory interface, and a dynamic RAM (DRAM) memory interface.

In one embodiment, controller hub 215 is a root hub, root complex, or root controller in a Peripheral Component Interconnect Express (PCIe or PCIE) interconnection hierarchy. Examples of controller hub 215 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 205, while controller 215 is to communicate with I/O devices, in a similar manner as described below. In some embodiments, peer-to-peer routing is optionally supported through root complex 215.

Here, controller hub 215 is coupled to switch/bridge 220 through serial link 219. Input/output modules 217 and 221, which may also be referred to as interfaces/ports 217 and 221, include/implement a layered protocol stack to provide communication between controller hub 215 and switch 220. In one embodiment, multiple devices are capable of being coupled to switch 220.

Switch/bridge 220 routes packets/messages from device 225 upstream, i.e. up a hierarchy towards a root complex, to controller hub 215 and downstream, i.e. down a hierarchy away from a root controller, from processor 205 or system memory 210 to device 225. Switch 220, in one embodiment, is referred to as a logical assembly of multiple virtual PCI-to-PCI bridge devices. Device 225 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 225 may include a PCIe to PCI/PCI-X bridge to support legacy or other version PCI devices. Endpoint devices in PCIe are often classified as legacy, PCIe, or root complex integrated endpoints.

Graphics accelerator 230 is also coupled to controller hub 215 through serial link 232. In one embodiment, graphics accelerator 230 is coupled to an MCH, which is coupled to an ICH. Switch 220, and accordingly I/O device 225, is then coupled to the ICH. I/O modules 231 and 218 are also to implement a layered protocol stack to communicate between graphics accelerator 230 and controller hub 215. Similar to the MCH discussion above, a graphics controller or the graphics accelerator 230 itself may be integrated in processor 205.

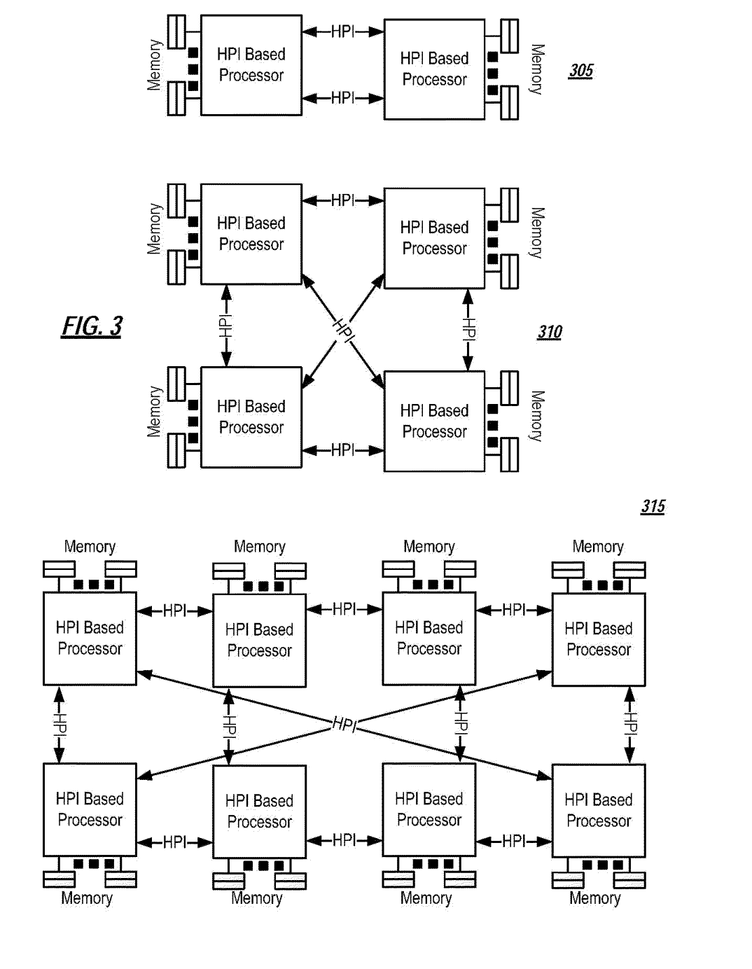

In one embodiment, a high performance interconnect (“HPI”) architecture can be provided for utilization in high performance computing platforms, such as workstations or servers. To support multiple devices, in one implementation, an Instruction Set Architecture (ISA) agnostic can be provided allowing the interconnect architecture to be implemented in multiple different devices. FIG. 3 illustrates an embodiment of multiple potential multi-socket configurations utilizing such interconnect architectures. A two-socket configuration 305, as depicted, includes two HPI links; however, in other implementations, one HPI link may be utilized. For larger topologies, any configuration may be utilized as long as an ID is assignable and there is some form of virtual path. As shown 4 socket configuration 310 has an HPI link from each processor to another. But in the 8 socket implementation shown in configuration 315, not every socket is directly connected to each other through an HPI link. However, if a virtual path exists between the processors, the configuration is supported. A range of supported processors includes 2-32 in a native domain. Higher number of processors may be reached through use of multiple domains or other interconnects between node controllers.

The HPI architecture includes a definition of a layered protocol architecture, which is similar to PCIe in that it also includes a layered protocol architecture. In one embodiment, HPI defines protocol layers (coherent, non-coherent, and optionally other memory based protocols), a routing layer, a link layer, and a physical layer. Furthermore, as many other interconnect architecture's HPI includes enhancements related to power managers, design for test and debug (DFT), fault handling, registers, security, etc.

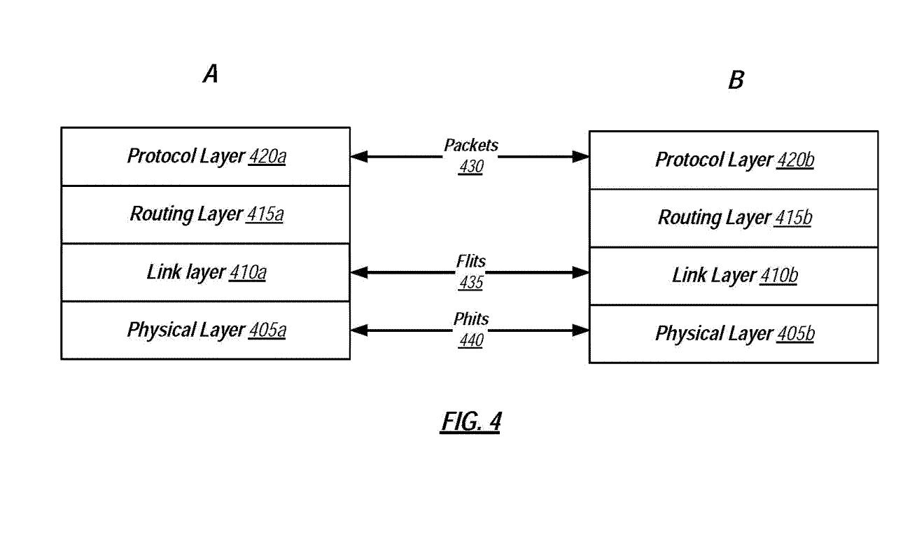

FIG. 4 illustrates an embodiment of potential layers in the HPI layered protocol stack; however, these layers are not required and may be optional in some implementations. Each layer deals with its own level of granularity or quantum of information (the protocol layer 405a,b with packets 430, link layer 410a,b with flits 435, and physical layer 405a,b with phits 440). Note that a packet, in some embodiments, may include partial flits, a single flit, or multiple flits based on the implementation.

As a first example, a width of a phit 440 includes a 1 to 1 mapping of link width to bits (e.g. 20 bit link width includes a phit of 20 bits, etc.). Flits may have a greater size, such as 184, 192, or 200 bits. Note that if phit 440 is 20 bits wide and the size of flit 435 is 184 bits then it takes a fractional number of phits 440 to transmit one flit 435 (e.g. 9.2 phits at 20 bits to transmit an 184 bit flit 435 or 9.6 at 20 bits to transmit a 192 bit flit). Note that widths of the fundamental link at the physical layer may vary. For example, the number of lanes per direction may include 2, 4, 6, 8, 10, 12, 14, 16, 18, 20, 22, 24, etc. In one embodiment, link layer 410a,b is capable of embedding multiple pieces of different transactions in a single flit, and within the flit multiple headers (e.g. 1, 2, 3, 4) may be embedded within the flit. Here, HPI splits the headers into corresponding slots to enable multiple messages in the flit destined for different nodes.

Physical layer 405a,b, in one embodiment, is responsible for the fast transfer of information on the physical medium (electrical or optical etc.). The physical link is point to point between two Link layer entities, such as layer 405a and 405b. The Link layer 410a,b abstracts the Physical layer 405a,b from the upper layers and provides the capability to reliably transfer data (as well as requests) and manage flow control between two directly connected entities. It also is responsible for virtualizing the physical channel into multiple virtual channels and message classes. The Protocol layer 420a,b relies on the Link layer 410a,b to map protocol messages into the appropriate message classes and virtual channels before handing them to the Physical layer 405a,b for transfer across the physical links. Link layer 410a,b may support multiple messages, such as a request, snoop, response, writeback, non-coherent data, etc.

In some implementations, link layer 410a,b can utilize a credit scheme for flow control. During initialization, a sender is given a set number of credits to send packets or flits to a receiver. Whenever a packet or flit is sent to the receiver, the sender decrements its credit counters by one credit which represents either a packet or a flit, depending on the type of virtual network being used. Whenever a buffer is freed at the receiver, a credit is returned back to the sender for that buffer type. When the sender's credits for a given channel have been exhausted, in one embodiment, it stops sending any flits in that channel. Essentially, credits are returned after the receiver has consumed the information and freed the appropriate buffers.

In one embodiment, routing layer 415a,b provides a flexible and distributed way to route packets from a source to a destination. In some platform types (for example, uniprocessor and dual processor systems), this layer may not be explicit but could be part of the Link layer 410a,b; in such a case, this layer is optional. It relies on the virtual network and message class abstraction provided by the Link Layer 410a,b as part of the function to determine how to route the packets. The routing function, in one implementation, is defined through implementation specific routing tables. Such a definition allows a variety of usage models.

In one embodiment, protocol layer 420a,b implement the communication protocols, ordering rule, and coherency maintenance, I/O, interrupts, and other higher-level communication. Note that protocol layer 420a,b, in one implementation provides messages to negotiate power states for components and the system. As a potential addition, physical layer 405a,b may also independently or in conjunction set power states of the individual links.

Multiple agents may be connect to an HPI architecture, such as a home agent (orders requests to memory), caching (issues requests to coherent memory and responds to snoops), configuration (deals with configuration transactions), interrupt (processes interrupts), legacy (deals with legacy transactions), non-coherent (deals with non-coherent transactions), and others.

Interconnect architectures can provide error containment features that protect against the propagation of corrupt data to fixed storage media. For instance, a viral mode or condition can be provided that can be triggered by an uncorrectable or catastrophic error detected in the system. Setting or entering viral mode can cause all packets of transactions and traffic on the data links of the interconnect architecture to indicate (e.g., through the setting of a viral status bit) that viral mode has been set. This viral notification is propagated across the system and causes component functions, such as input/output (I/O) functions to be automatically stopped or blocked to prevent the error from propagating. With the error contained, all traffic within the system can be quiesced and the system can be reset. In some implementations, a viral status bit can be provided in protocol level messages and can be included in pre-defined control flit fields, among other potential implementations.

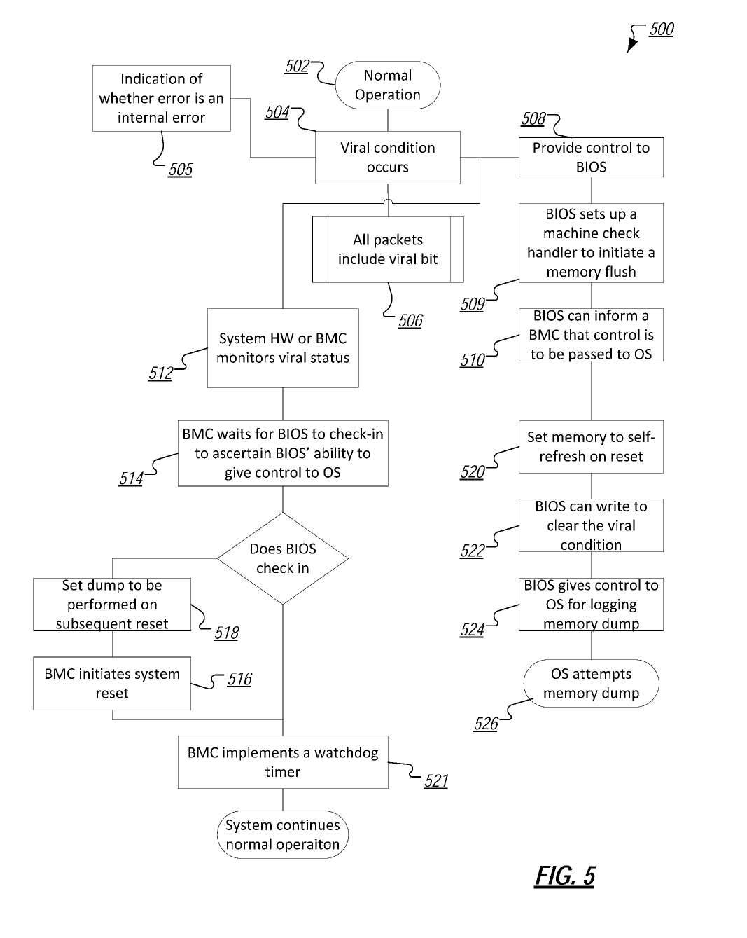

It can be desirable to diagnose the cause of uncorrectable or catastrophic errors so as to identify the source, nature, and location of the error. A memory dump can be used to collect data from the system documenting the status and attributes of various components of the system at or near (e.g., preceding) the time of the detection of an error. Memory dump data can be analyzed to determine the cause of the error. However, in some implementations of a viral mode, the ability to obtain memory dump data while preserving the high level of error containment promised by the viral mode can be in conflict. For instance, viral mode can block all I/O transactions and block data, including memory dump data, from reaching fixed disk memory. Turning to FIG. 5, a flowchart 500 is shown of an example workaround to enable a memory dump in connection with a viral condition being set by a catastrophic error. For instance, while a system is operating normally 502 (e.g., not in viral mode), a viral condition can occur 504 in the CPU complex of the system, for instance, from propagation of a viral message (e.g., in a packet received from another component with the viral status bit set) or detection of an internal error at the CPU (e.g., 505), etc. With the system in viral condition all packets sent from this point can also be set to indicate viral 506, causing a system-wide viral condition to occur as the viral condition is propagated through the system. I/O operations can also be aborted during the viral condition. The system BIOS can then be provided control 508 of the system in a system management mode (SMM), for instance, in connection with a system management interrupt (SMI). The BIOS can wait until confirming that all traffic within the system at the time of the viral condition has quiesced. The BIOS can then set up 509 a machine check architecture (MCA) handler that initiates a flush of cache to memory to preserve memory context for the dump. The BIOS, in this example, can inform 510 a baseboard management controller (BMC) that it will be passing control to the operating system. This can serve to ensure that the BMC will not interfere with the preservation of the memory dump. In some instantiations, the BMC can monitor BIOS progress and attempt to recover the system if BIOS fails to pass control. The BMC can monitor 512 viral state and further monitor 514 for BIOS to check-in with the BMC to ascertain whether BIOS is able to give control the operating system. If not, the BMC can initiate reset 516 and even, in some implementations, set BMC memory to self-refresh and perform a memory dump 518 on a subsequent reset (e.g., outside of viral). Otherwise, operation of the system continues as normal. In some implementations, the BMC can additionally implement a watchdog timer (WDT) 521 to ensure that the operating system does not hang, and initiate a reset sequence if a problem is detected in the operation of the operating system, among other examples.

Further, the memory where the dump data is flushed to can be also set to self-refresh 520 or otherwise guard against a system reset or shutdown cycle that could potentially erase all or a portion of the dump data. The BIOS can then write to clear 522 the viral condition and disabling viral propagation at the particular node where dump storage is located and pass control 524 to the operating system to attempt to perform the memory dump 526. While this example workaround allows the dump to occur, clearing the viral condition removes the guaranty of error containment and opens up the system to potentially going viral and corrupt data from reaching fixed storage in connection with the memory dump (i.e., as it outside of the viral mode protections). In addition, such a workaround can cause a loss of sticky error registers of the CPU complex. This can prevent other diagnosis of alternate silicon failure not evident by the memory dump itself.

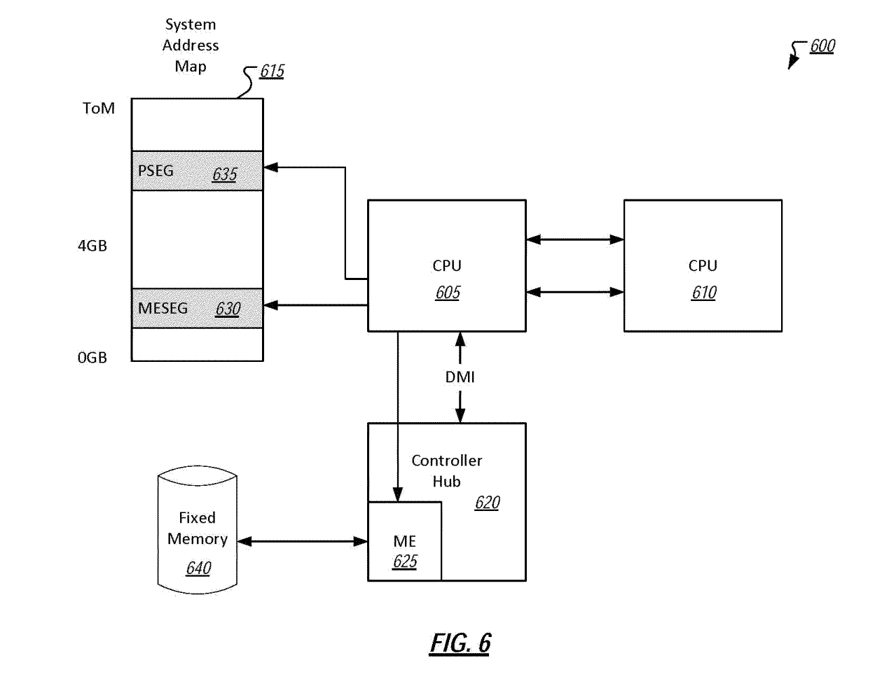

Turning to the simplified block diagram 600 of FIG. 6, improved systems can be provided that can permit a memory dump during a viral or other error containment state, allowing for complete error containment and reliable memory dumps in connection with the detection of a catastrophic or uncorrectable error, among other potential advantages. In the example of FIG. 6, a system is shown including one or more CPU devices 605, 610, and system memory represented by address map 615. The system can further include a controller hub 620 capable of communicating with the CPU devices 605, 610 and system memory using one or more interconnect architectures. In the present example, controller hub 620 can further include a hardware-based management engine 625 or other agent managing a protected and private segment of memory (e.g., management engine memory segment (“MESEG”) 630). MESEG 630 can be a separate region controlled by a dedicated hardware range register (e.g., management engine 625). For instance, transactions involving MESEG can be implemented as a specialized traffic class (e.g., traffic class 7 (TC7)) that are only initiated by the corresponding management engine 625. Accordingly, the management engine can have exclusive control over the memory segment and the memory segment 630 can be protected from access by an operating system of the system. Other protected memory segments can also (or alternatively) be provided such as protected memory segment (“PSEG”) 635 which can also be protected from unilateral access by the operating system, among other examples.

Management engine 625 can include functionality for performing general purpose direct memory access transactions to main memory (e.g., 615), and specifically to MESEG 630. Transactions of the management engine 625 can be tagged with specialized traffic classes corresponding to quality of service levels that are treated preferentially relative to at least some other transactions. Further, transactions tagged with such specialized traffic classes may be permitted within a viral condition on the system. For instance, one such specialized traffic class can be a traffic class corresponding to general direct memory access (DMA) transactions targeting main system memory. An additional or substitute specialized traffic class can include a specialized traffic class corresponding to private chipset to host-owned memory traffic, such as transactions specifically targeting system memory ranges (e.g., MESEG 630) dedicated to such components as management engine 625. For instance, transactions of a particular traffic class (utilized as the specialized traffic class) can be configured to be decoupled from host traffic and only target predefined ranges of memory, among other examples. In either instance, specialized traffic classes, when targeting protected, or private memory segments, can function to provide a private memory channel dedicated to direct memory access of corresponding private memory segments. Such private memory channels can be used, in some implementations, to dump memory corresponding to a catastrophic error while the system is still in a viral condition (i.e., resulting from the catastrophic error). The owner of the private memory segment (e.g., management engine 625 or another component) can then take the memory dump and move it to private fixed disk memory (e.g., 640) prior to a system reset, allowing for the memory dump to take place and be secured while maintaining error containment provided through the viral state.

In some implementations, a system can include security properties such that channels (e.g., virtual channels) provided within the system for directed I/O are configured to block certain accesses of system memory such that the operating system (or another system entity) can be assured that other devices in the system possessing DMA properties cannot read or write to memory segments not belonging to them. Such protections can be enforced, for examples, by both the CPU (e.g., 605, 610), controller hub 620, and translation checks performed, for instance, within the CPU and controller hub 620. Such protections can be enabled and include hardware support for isolating and restricting device accesses to the owners of a respective memory partition.

In one example, viral mode, while causing I/O operations to be aborted to protect I/O data from reaching persistent memory (e.g., fixed disk), may not protect volatile system memory (e.g., DRAM), allowing for at least some memory accesses within the viral condition. This subset of memory accesses can include DMA transactions and other memory writes. For instance, while in viral state, BIOS can dynamically allow an operating system crash dump handler or other component to write to a protected memory region (e.g., 630, 635) as the destination of a crash dump instead of fixed media. Because the operating system is writing to system memory during viral, the CPU will allow such transactions to occur even while in viral state. The owner of the protected memory region can then access the memory dump data written to the protected memory region and stored the crash dump in a private, protected file system apart from the fixed disk persistent memory of the system protected by the viral condition. The mission critical aspects of the viral state can be maintained, ensuring that data corruption does not hit the local fixed disk, while also permitting an effective crash dump for failure analysis.

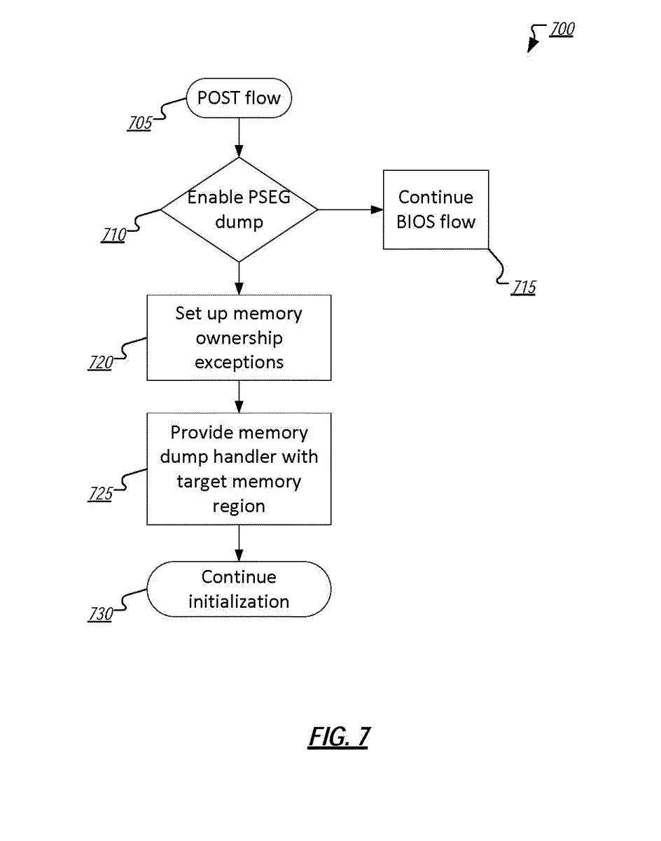

Turning to the example illustrated in the flowchart 700 of FIG. 7, in some instances, a CPU may not possess default privileges to write to or otherwise access protected memory segments defined in system memory, thereby also allowing access to such protected memory segments by the operating system to be restricted. In one example, the ability of the operating system to write to a protected memory segment can be selectively and temporarily enabled (e.g., by BIOS) to allow crash dump data to be written to the protected memory segment. For instance, in one example, a protected memory region can have attributes of read/write lock back (“RW-LB”) which allows the BIOS to dynamically change the protected segment to be read/write during certain defined windows, such as from SMM. As a result, the ability to perform such crash dumps (e.g., through a protected memory segment and channel that cannot be snooped by the operating system) can be selectively enabled and disabled.

In one example, during a power-on self-test (POST) flow 705 and prior to a system be placed in a viral condition, it can be determined 710 whether protected memory dump functionality is to be enabled. In some instances, protected memory dump functionality can be selectably or dynamically enabled and disabled. If it is determined that the protected memory dump functionality should not be enabled, then BIOS flow continues 715 as normal. If it is determined that the protected memory dump functionality should be enabled, BIOS can instruct 720 that only writes to the corresponding protected memory segment ranges are permitted to bypass those security properties restricting device accesses to the owner of a respective partition (e.g., the particular protected memory segments). For instance, the CPU (e.g., using uncore functions) can log the address(es) of the protected memory segment to be designated as the target of the memory dump, for instance, by logging the addresses in a region of upper memory (UMA). A management engine or other tool can access the logged addresses to determine where to find memory dump data in the protected memory for writing to private fixed memory, among other examples. The BIOS can then provide 725 the components of the operating system responsible for performing the memory dump, such as a memory dump handler of the operating system, with the target addresses (in protected memory) for memory dumps occurring when viral condition is set. BIOS can provide 725 an indication of the memory dump target, for instance, through an Advance Configuration and Power Interface (ACPI) table or other data structure for communicating device configuration between hardware devices and the operating system. This can complete initialization of the protected memory dump functionality and BIOS can continue 730 with remaining system initialization steps.

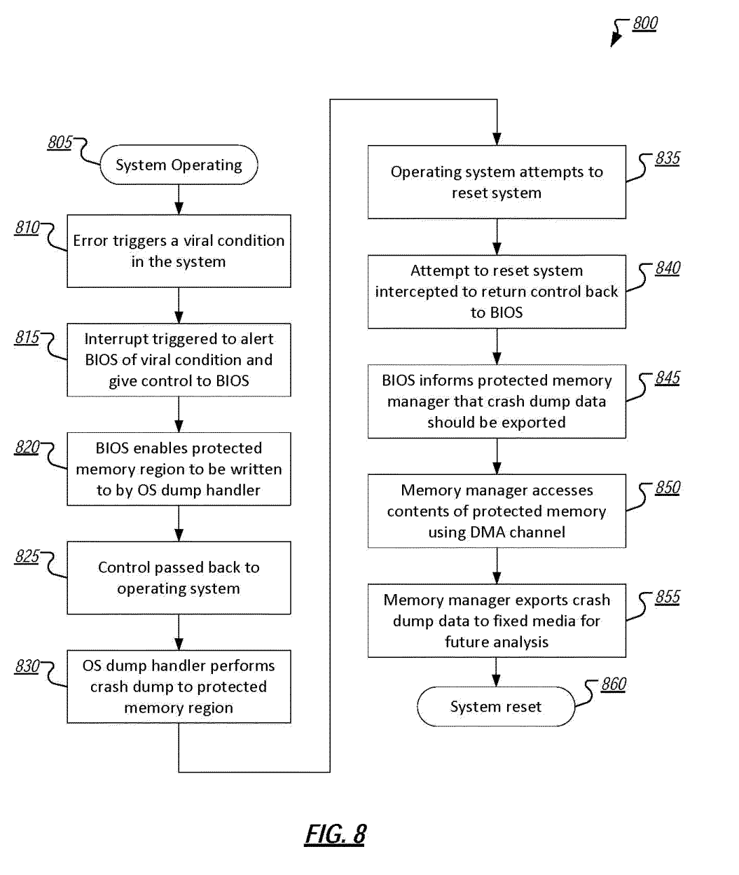

Turning to the example illustrated in the flowchart 800 of FIG. 8, with protected memory dump functionality enabled, a system can operate, with the operating system of the system running 805 at the time an error triggering a viral condition in the system occurs 810. A system management interrupt (SMI) or other interrupt can be triggered 815, for example, by the CPU, chipset, or other component to alert BIOS of the viral error and the setting of the viral condition within the system. The SMI can cause BIOS to enter system management mode (SMM) where the BIOS temporarily enables 820 the protected memory to be written to by the operating system (i.e., which would otherwise be blocked from accessing the protected memory). Control can then be passed 825 back to the operating system and the operating system (e.g., using a crash dump handler) can then perform 830 the crash dump by taking advantage of the window of access to the protected memory and writing crash dump data to the protected memory region. The operating system can then attempt to reset 835 the platform, for instance, in response to determining or predicting that the viral traffic has successfully quiesced. The attempt to reset 835 can be intercepted 840, for instance, by a controller hub, causing another interrupt to be triggered 840 returning control to the BIOS, for instance, in a SMM. The BIOS can inform 845 a component managing the protected memory, such as a management engine, management engine acting as a BMC, or other component that a reset is forthcoming and that the recently written crash dump data in the protected memory should be exported to fixed media of the component (e.g., fixed media separate and apart from the fixed disk of the system protected through the viral condition). The component, such as a management engine, can utilize specialized channels to read 850 from the protected memory and then export 855 the crash dump data from the protected memory to fixed media that can be later accessed for future analysis of the error causing (e.g., at 810) the viral condition. With the crash dump data safely exported to a persistent memory, the system can then be reset 860.

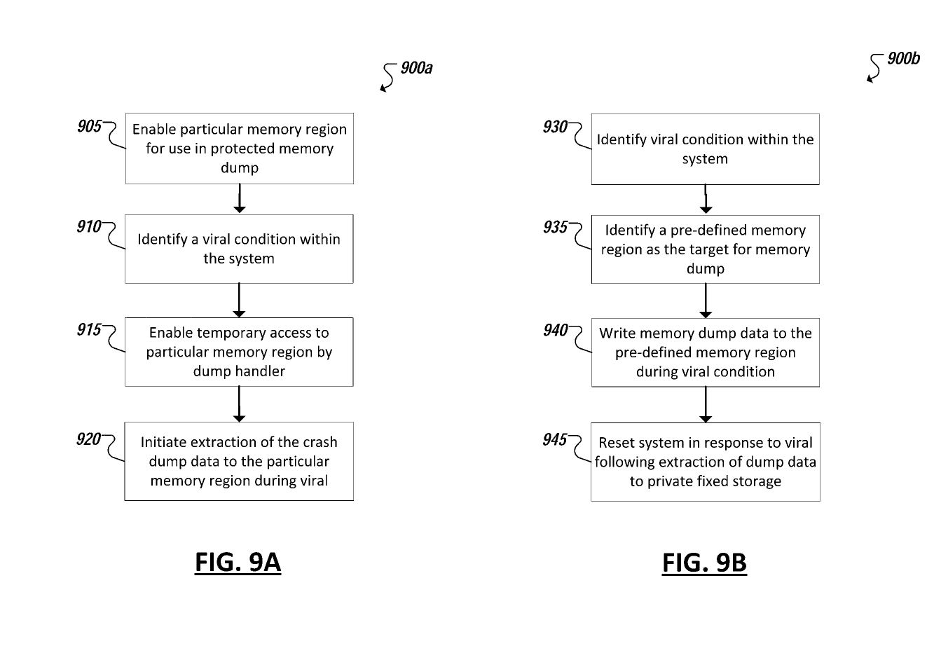

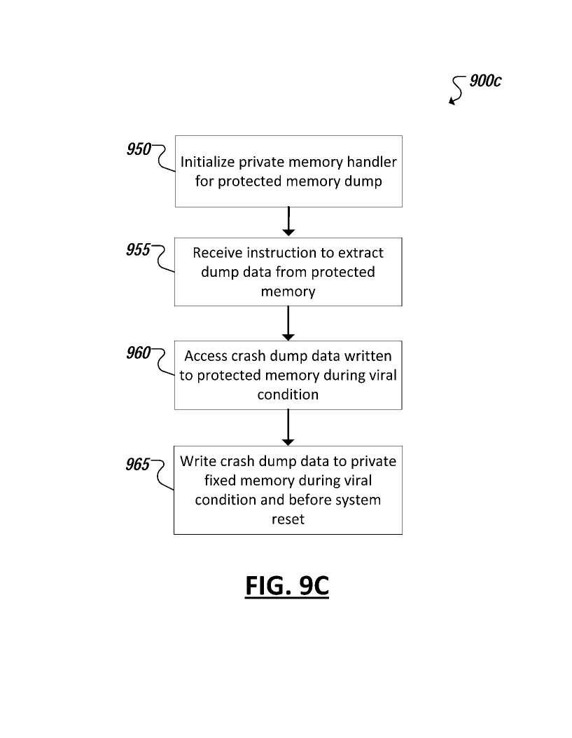

Turning now to the simplified flowcharts 900a-c of FIGS. 9A-9C, more generalized techniques capable of being performed in connection with a protected memory dump are discussed. For instance, in the example of FIG. 9A, instructions, such as instructions included in system BIOS, can be executed by a processor of a system to enable and initialize (at 905) a protected memory location to be utilized in a protected memory dump during (and in response to) a viral condition that may be triggered within the system. Protected memory dump functionality can be selectively enabled, in that it is disabled and unavailable in some instances of a viral error. Initialization of the protected memory dump functionality can include setting exceptions for security protections that lock out entities (e.g., the operating system) from accessing memory that is not assigned to the entity, among other examples (such as the examples included and discussed in connection with the example flow of FIG. 7). If the protected memory has been enabled, upon the triggering of a viral condition within the system (e.g., in response to a catastrophic error), the viral condition can be received at a controller which can identify (e.g., at 910) the condition to BIOS or another sub-system. Access to the particular memory location designated and enabled for a protected crash dump can be at least temporarily granted or enabled (at 915) to the component (e.g., an OS crash dump handler) responsible for collecting crash dump data from the system and performing (e.g., writing) the crash dump. With the crash dump data written to the particular memory segment, prior to reset of the system and while the system is still in viral, extraction of the crash dump data from the particular volatile memory region (e.g., of system memory) can be initiated such that the crash dump data is safely extracted to less-volatile, fixed media for future analysis. The system reset can then be allowed to proceed.

Turning to the example of FIG. 9B, the viral condition within the system can be identified 930, as well, for example, by the operating system of the system. BIOS, for instance, can identify 935 a pre-defined memory region as a target for memory dumps when the system is in viral and the crash dump handler or another utility of the operating system can utilize this information in targeting deposit of the crash dump data. The memory region can be defined as the target, for instance, in connection with the enabling and initialization (e.g., at 905) of protected memory region, and can be identified 935 as the memory dump target, for instance, from a table or other data structure pointing to the particular memory region. The memory dump data can be written 940 to the pre-defined memory region during the viral condition, for instance, in connection with the temporary enabling of access to the pre-defined memory region by the operating system (e.g., where the memory region is a private memory region and access to the region is ordinarily restricted to the utility (other than the operating system) controlling or managing the memory region). In some implementations, the particular memory region can be written (e.g., by the host CPU (e.g., through the BIOS or a OS utility)) to utilizing a specialized channel, such as a DMA channel, such as a T0 or T7, among other examples. The system can then be attempted to be reset 945. The attempt can trigger an interrupt to prompt the manager of the written-to memory location to extract the crash dump data to fixed media prior to the reset being completed.

Turning to the example of FIG. 9C, a private memory handler owning a private memory region (e.g., with restricted access by an operating system) can be initialized to participate in a protected memory dump in connection with viral conditions triggered within a system. Following the triggering of a viral condition within a system (and enabling of a protected crash dump within viral conditions), an instruction can be received (e.g., from BIOS) to extract dump data that has been written to (e.g., by an OS dump handler) the private memory region in connection with the enabled protected crash dump during the viral condition. The crash dump data can be accessed 960, for instance, using a specialized channel, during the viral condition and the crash dump data can be extracted 965 to fixed media by writing the crash dump data to a private fixed memory device before the system is reset in response to the viral condition.

Note that the apparatus', methods', and systems described above may be implemented in any electronic device or system as aforementioned. As specific illustrations, the examples below provide exemplary systems for utilizing the invention as described herein. As the systems below are described in more detail, a number of different interconnects are disclosed, described, and revisited from the discussion above. And as is readily apparent, the advances described above may be applied to any of those interconnects, fabrics, or architectures.

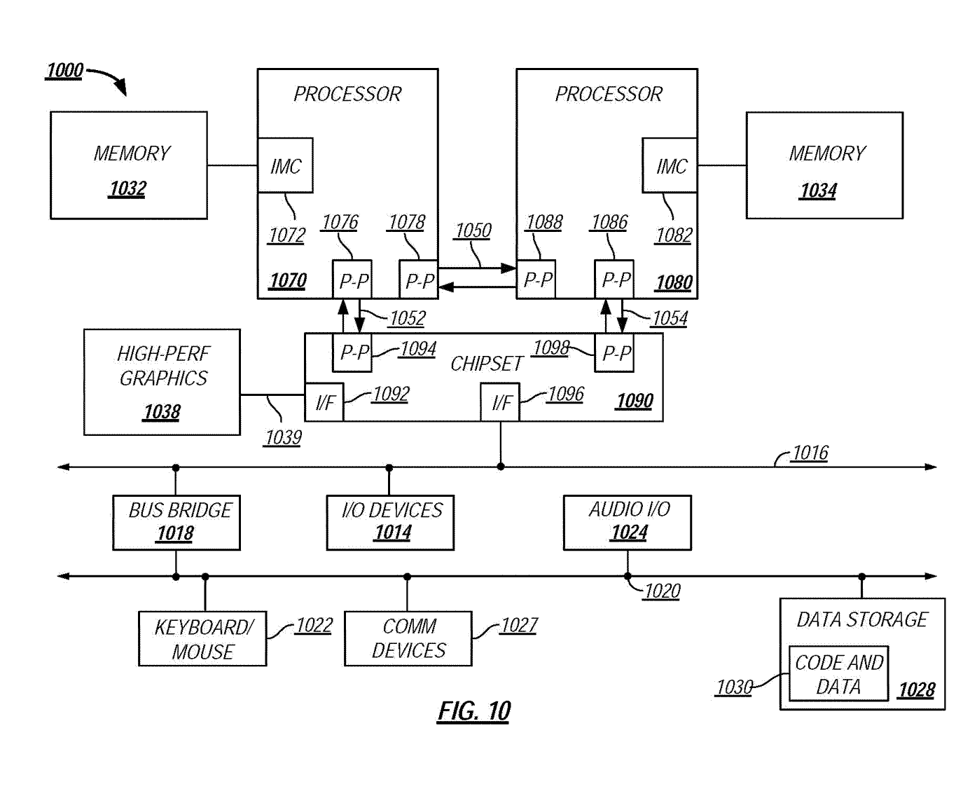

Referring now to FIG. 10, shown is a block diagram of a second system 1000 in accordance with an embodiment of the present invention. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of a processor. In one embodiment, 1052 and 1054 are part of a serial, point-to-point coherent interconnect fabric, such as Intel's Quick Path Interconnect (QPI) architecture. As a result, the invention may be implemented within the QPI architecture.

While shown with only two processors 1070, 1080, it is to be understood that the scope of the present invention is not so limited. In other embodiments, one or more additional processors may be present in a given processor.

Processors 1070 and 1080 are shown including integrated memory controller units 1072 and 1082, respectively. Processor 1070 also includes as part of its bus controller units point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10, IMCs 1072 and 1082 couple the processors to respective memories, namely a memory 1032 and a memory 1034, which may be portions of main memory locally attached to the respective processors.

Processors 1070, 1080 each exchange information with a chipset 1090 via individual P-P interfaces 1052, 1054 using point to point interface circuits 1076, 1094, 1086, 1098. Chipset 1090 also exchanges information with a high-performance graphics circuit 1038 via an interface circuit 1092 along a high-performance graphics interconnect 1039.

A shared cache (not shown) may be included in either processor or outside of both processors; yet connected with the processors via P-P interconnect, such that either or both processors' local cache information may be stored in the shared cache if a processor is placed into a low power mode.

Chipset 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present invention is not so limited.

As shown in FIG. 10, various I/O devices 1014 are coupled to first bus 1016, along with a bus bridge 1018 which couples first bus 1016 to a second bus 1020. In one embodiment, second bus 1020 includes a low pin count (LPC) bus. Various devices are coupled to second bus 1020 including, for example, a keyboard and/or mouse 1022, communication devices 1027 and a storage unit 1028 such as a disk drive or other mass storage device which often includes instructions/code and data 1030, in one embodiment. Further, an audio I/O 1024 is shown coupled to second bus 1020. Note that other architectures are possible, where the included components and interconnect architectures vary. For example, instead of the point-to-point architecture of FIG. 10, a system may implement a multi-drop bus or other such architecture.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. One or more embodiments may provide an apparatus, a system, a machine readable storage, a machine readable medium, and a method to identify a viral condition, wherein input/output operations are to be restricted during the viral condition, enable crash dump data to be written to a particular region of volatile memory during the viral condition, and initiate extraction of the crash dump data to fixed memory during the viral condition.

In at least one example, the viral condition is to be identified from a viral message included in a packet, and the viral message is to indicate identification of the viral condition at one or more components within the system.

In at least one example, the crash dump data is to be written to the particular region using a direct memory access channel. Traffic on the direct memory access channel can be exempted from restrictions to input/output operations of the viral condition.

In at least one example, the crash dump data is to be written to the particular region using a channel reserved for access to private memory including the particular region.

In at least one example, the extraction of the crash dump data is to occur prior to a reset of the system based on the viral condition.

In at least one example, the particular region is included in protected memory. Access to the protected memory by an operating system of the system can be restricted.

In at least one example, extraction of the crash dump data to fixed memory can be initiated by a management engine corresponding to the particular region, where the particular region comprises private memory of the management engine.

In at least one example, extraction of the crash dump data to fixed memory can be initiated by a baseboard management controller (BMC).

In at least one example, prior to the viral condition, crash dumps to the particular region in response to future viral conditions on the system can be initialized. The initialization can identify an address of the particular region as a target for crash dumps in response to future viral conditions on the system.

One or more embodiments may provide an apparatus, a system, a machine readable storage, a machine readable medium, and a method to identify a viral condition within a system, where input/output operations are to be restricted during viral condition, identify a particular pre-defined region of volatile memory enabled for a memory dump, and write memory dump data to the pre-defined region during the viral condition.

In at least one example, the system is to be attempted to be reset after the memory dump, and the reset is to be interrupted to allow contents of the pre-defined region to be written to fixed memory prior to the reset.

In at least one example, the system is to be attempted to be reset following the writing of the contents of the pre-defined region to be written to the fixed memory.

In at least one example, memory dump data is to be written by an operating system of the system, the particular region is a private memory region of a particular entity of the system other than the operating system, and access to the particular region by the operating system is blocked when the particular region is not enabled for the memory dump.

In at least one example, the fixed memory includes private fixed memory separate from a fixed memory of the system, access to the fixed memory of the system is restricted during the viral condition, and the private fixed memory corresponds to the particular entity.

In at least one example, the particular region is a protected region of the memory.

In at least one example, the memory dump data is to be analyzed from the private fixed memory.

In at least one example, the dump data is to be written to the particular region using a direct memory access channel.

In at least one example, transactions involving the particular region and using the direct memory access channel are exempted during the viral condition.

In at least one example, an error causing the viral condition is identified, a bit of a packet to be sent to other devices in the system is set to indicate the viral condition, and the packet is sent to the other devices.

One or more embodiments may provide an apparatus, a system, a machine readable storage, a machine readable medium, and a method to identify a viral condition within a system, wherein input/output operations are to be restricted during the viral condition, enable crash dump data to be written to a particular region of volatile memory during the viral condition, and initiate extraction of the crash dump data to fixed memory during the viral condition.

In at least one example, prior to an error causing the viral condition, crash dumps to the particular region in response to future viral conditions on the system are to be initialized.

In at least one example, the system is to be reset in response to the viral condition and the reset is to be interrupted until the crash dump data is extracted to the fixed memory.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
I/O logic to:
identify a viral condition, wherein input/output operations are to be restricted during the viral condition;
enable crash dump data to be written to a particular region of volatile memory during the viral condition; and
initiate extraction of the crash dump data to fixed memory during the viral condition.

2. The apparatus of claim 1, wherein the viral condition is to be identified from a viral message included in a packet, and the viral message is to indicate identification of the viral condition at one or more components within a system.

3. The apparatus of claim 1, wherein the crash dump data is to be written to the particular region using a direct memory access channel.

4. The apparatus of claim 3, wherein traffic on the direct memory access channel is to be exempted from restrictions to input/output operations of the viral condition.

5. The apparatus of claim 1, wherein the crash dump data is to be written to the particular region using a channel reserved for access to private memory including the particular region.

6. The apparatus of claim 1, wherein the extraction of the crash dump data is to occur prior to a reset of a system based on the viral condition.

7. The apparatus of claim 1, wherein the particular region is included in protected memory.

8. The apparatus of claim 7, wherein access to the protected memory by an operating system of a system is restricted.

9. The apparatus of claim 1, wherein the I/O logic is to initiate extraction of the crash dump data to fixed memory by a management engine corresponding to the particular region, wherein the particular region comprises private memory of the management engine.

10. The apparatus of claim 1, wherein the I/O logic is to initiate extraction of the crash dump data to fixed memory by a baseboard management controller (BMC).

11. The apparatus of claim 1, wherein the I/O logic is further to initialize, prior to the viral condition, crash dumps to the particular region in response to future viral conditions on a system.

12. The apparatus of claim 11, wherein the initialization identifies an address of the particular region as a target for crash dumps in response to future viral conditions on the system.

13. An apparatus comprising:
logic to:
identify a viral condition within a system, wherein input/output operations are to be restricted during viral condition;
identify a particular pre-defined region of volatile memory enabled for a memory dump; and
write memory dump data to the pre-defined region during the viral condition.

14. The apparatus of claim 13, wherein the logic is further to attempt to reset the system after the memory dump, wherein the reset is to be interrupted to allow contents of the pre-defined region to be written to fixed memory prior to the reset.

15. The apparatus of claim 14, wherein the system is to be reset following the writing of the contents of the pre-defined region to be written to the fixed memory.

16. The apparatus of claim 14, wherein memory dump data is to be written by an operating system of the system, the particular region is a private memory region of a particular entity of the system other than the operating system, and access to the particular region by the operating system is blocked when the particular region is not enabled for the memory dump.

17. The apparatus of claim 16, wherein the fixed memory comprises private fixed memory separate from a fixed memory of the system, access to the fixed memory of the system is restricted during the viral condition, and the private fixed memory corresponds to the particular entity.

18. The apparatus of claim 16, wherein particular region comprises a protected region of the memory.

19. The apparatus of claim 16, further comprising logic to analyze the memory dump data from the private fixed memory.

20. The apparatus of claim 13, wherein the dump data is to be written to the particular region using a direct memory access channel.

21. The apparatus of claim 20, wherein transactions involving the particular region and using the direct memory access channel are exempted during the viral condition.

22. The apparatus of claim 13, further comprising logic to:
identify an error;
set a bit of a packet to be sent to other devices in the system to indicate the viral condition; and
send the packet to the other devices.

23. At least one machine accessible storage medium having instructions stored thereon, the instructions when executed on a machine, cause the machine to:
identify a viral condition within a system, wherein input/output operations are to be restricted during the viral condition;
enable crash dump data to be written to a particular region of volatile memory during the viral condition; and
initiate extraction of the crash dump data to fixed memory during the viral condition.

24. The storage medium of claim 23, wherein the instructions, when executed, further cause the machine to initialize, prior to an error causing the viral condition, crash dumps to the particular region in response to future viral conditions on the system.

25. The storage medium of claim 23, wherein the system is to be reset in response to the viral condition and the reset is to be interrupted until the crash dump data is extracted to the fixed memory.

26. A method comprising:
identifying a viral condition within a system, wherein input/output operations are to be restricted during the viral condition;
enabling crash dump data to be written to a particular region of volatile memory during the viral condition; and
initiating extraction of the crash dump data to fixed memory during the viral condition.
